(19) United States
(12) Patent Application Publication
(10) Pub. No.: US 2025/0127074 A1
(43) Pub. Date: Apr. 24, 2025

(54) Portable Seed Treatment System mounted with a Calibration Hopper and Inline Conveyors

(71) Applicant: KSi Conveyor, Inc., Sabetha, KS (US)

(72) Inventors: Cesar F. Francisco, JR., Cissna Park, IL (US); Corbin Anliker, Sabetha, KS (US); Dominic E. Meyer, Sabetha, KS (US)

(73) Assignee: KSi Conveyor, Inc., Sabetha, KS (US)

(21) Appl. No.: 18/901,751

(22) Filed: Sep. 30, 2024

Related U.S. Application Data
(60) Provisional application No. 63/591,981, filed on Oct. 20, 2023.

(51) Int. Cl. A01C 1/06; B65G 47/19; G01F 9/00; G01F 25/20

(52) U.S. Cl. CPC A01C 1/06; B65G 47/19; G01F 9/00; G01F 25/20; B65G 2201/0202

(57) ABSTRACT

A portable seed treatment system has a trailer with inlet and outlet conveyors mounted inline. A calibration hopper having lower and upper conical sections is mounted between the inlet and outlet conveyors. A gate of the calibration hopper selectively closes an aperture in the lower conical section during a calibration phase. A low-level sensor disposed within lower conical section and a high-level sensor disposed within the upper conical section assist in obtaining a fill-time. A volumetric measurement is used to determine a measured seed flow rate of seed entering the calibration hopper. The gate opens after the calibration phase to allow seed to be treated. A treatment applicator receives seed at the measured seed flow rate under the force of gravity from the calibration hopper. Treatment applicator provides accurate amounts of seed treatment during a controlled release of seed from the seed source into the portable seed treatment system.

### CROSS REFERENCES

This application is a U.S. Non-Provisional Application which claims the benefit of U.S. Provisional Application No. 63/591,981, entitled “Portable Seed Treatment System mounted with a Calibration Hopper and Inline Conveyors”, filed on 20 Oct. 2023, which is incorporated herein by reference in its entirety.

### REFERENCE TO RESEARCH

Not Applicable.

### REFERENCE TO CDS Not Applicable.

### FIELD OF THE INVENTION

The present disclosure relates to a portable seed treatment apparatus used onsite to coat agricultural seed with a liquid treatment applied at a treatment flow rate that correlates with a seed flow rate as measured within a calibration hopper of the apparatus.

### BACKGROUND

Agricultural seed treatment systems may include conveyors mounted to a trailer used as a mobile platform for seed treatment operations. The mobile platform facilitates the treatment of seeds by the treatment system at a customer's site of operation. Such treatment systems may facilitate the transfer of treated seeds through the treatment equipment to a collection bin

### SUMMARY

In some aspects, the disclosure describes an agricultural seed treatment system including: (a) a trailer; (b) an inlet conveyor mounted to the trailer, the inlet conveyor including: (i) a discharge end; (c) an outlet conveyor mounted to the trailer inline with the inlet conveyor; (d) a hopper configured to receive agricultural seed from the inlet conveyor, the hopper including: (i) a lower conical section; (ii) an upper section; (iii) a hopper gate configured to selectively open and close an aperture in the lower conical section; (e) a low-level sensor disposed within the lower conical section of the hopper; (f) a high-level sensor disposed within the upper section of the hopper; and (g) an applicator configured to receive agricultural seed under the force of gravity from the hopper.

In some aspects, the disclosure describes an agricultural seed treatment system, further including: (a) a controller operably connected to the hopper gate, the low-level sensor, and the high-level sensor; and (b) wherein, during a calibration phase, the controller is configured to close the hopper gate and measure a fill time between reception of a low-level signal from the low-level sensor and a high-level signal from the high-level sensor.

In some aspects, the disclosure describes an agricultural seed treatment system, wherein the controller is further configured to calculate a seed flow rate based on the fill time and a volume of the hopper.

In some aspects, the disclosure describes an agricultural seed treatment system, further including: (a) a first liquid treatment source disposed on the trailer and operably connected to the applicator; (b) wherein the controller is configured to treat the agricultural seed with a first liquid treatment from the first liquid treatment source according to a recipe based on the seed flow rate.

In some aspects, the disclosure describes an agricultural seed treatment system, wherein the capacity of the hopper is between 2 cubic feet to 10 cubic feet.

In some aspects, the disclosure describes an agricultural seed treatment system, further including: (a) a transfer gate disposed upstream of the inlet conveyor to control the seed flow rate of agricultural seed.

In some aspects, the disclosure describes an agricultural seed treatment system, wherein the hopper is vertically disposed between the inlet conveyor and the outlet conveyor.

In some aspects, the disclosure describes an agricultural seed treatment system, wherein the hopper is vertically disposed below the discharge end of the inlet conveyor.

In some aspects, the disclosure describes an agricultural seed treatment system, wherein the applicator is vertically disposed below the lower conical section of the hopper.

In some aspects, the disclosure describes a method, including the steps of: (a) delivering a stream of agricultural seed from an inlet conveyor into a hopper of a portable treater; (b) filling the hopper disposed downstream of the inlet conveyor on the portable treater; (c) determining a seed flow rate based on a period to fill the hopper between a low-level sensor and a high-level sensor of the hopper during a calibration phase; and (d) adjusting a treatment flow rate of an applicator on the portable treater to continuously treat the stream of agricultural seed at the seed flow rate.

In some aspects, the disclosure describes a method, further including the step of: (a) closing a gate of the hopper; (b) receiving, by a controller, a low-level signal from the low-level sensor; (c) receiving, by the controller, a high-level signal from the high-level sensor; and (d) calculating, by the controller, the seed flow rate of the stream of agricultural seed delivered from the inlet conveyor into the hopper.

In some aspects, the disclosure describes a method, further including the step of: (a) treating, by the applicator, the stream of agricultural seed at the treatment flow rate that matches the seed flow rate determined during the calibration phase.

In some aspects, the disclosure describes a method, further including the step of: (a) receiving the stream of agricultural seed from the applicator into an outlet conveyor of the portable treater; and (b) mixing the stream of agricultural seed within the outlet conveyor.

In some aspects, the disclosure describes a method, wherein the hopper is disposed between the inlet conveyor and the outlet conveyor.

In some aspects, the disclosure describes a method, further including the step of: (a) adjusting, by the controller, the seed flow rate of the stream of agricultural seed with a transfer gate disposed upstream of the inlet conveyor.

In some aspects, the disclosure describes a method, further including the step of: (a) increasing, by the controller, a gap opening of the transfer gate based on an increase in an inflow rate of the stream of agricultural seed into the inlet conveyor; and (b) decreasing, by the controller, a gap opening of the transfer gate based on a decrease in the inflow rate of the stream of agricultural seed into the inlet conveyor.

In some aspects, the disclosure describes a method, further including the step of: (a) increasing the seed flow rate of the stream of agricultural seed through the inlet conveyor based on an increase in a gap opening of the transfer gate; and (b) decreasing the seed flow rate of the stream of agricultural seed through the inlet conveyor based on a decrease in the gap opening of the transfer gate.

In some aspects, the disclosure describes a method, wherein the seed flow rate is between 1,000 pounds per minute to 3,000 pounds per minute.

In some aspects, the disclosure describes an agricultural seed treatment system including: (a) a trailer; (b) an inlet conveyor mounted to the trailer, the inlet conveyor including: (c) a transfer gate disposed upstream of the inlet conveyor to control the seed flow rate of agricultural seed; (d) an outlet conveyor mounted to the trailer inline with the inlet conveyor, the outlet conveyor including: (i) an inlet end; (ii) a discharge end; and (e) an applicator disposed downstream of the inlet conveyor and configured to dispense agricultural seed under the force of gravity into the inlet end of the outlet conveyor.

In some aspects, the disclosure describes an agricultural seed treatment system, further including: (a) a hopper configured to receive agricultural seed from the inlet conveyor, the hopper including: (i) a lower conical section; (ii) an upper section; (iii) a hopper gate configured to selectively open and close an aperture in the lower conical section; (b) a low-level sensor disposed within the lower conical section of the hopper; (c) a high-level sensor disposed within the upper section of the hopper; and (d) wherein the applicator is configured to receive agricultural seed under the force of gravity from the hopper.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 depicts an example of a portable seed treater with a calibration hopper positioned between an inlet conveyor and an outlet conveyor that are mounted inline.

FIG. 2 depicts an example of a calibration hopper vertically aligned with a treatment applicator that is disposed below.

FIG. 3 depicts an example of a treatment applicator in operation within a treatment chamber of the portable seed treater.

FIG. 4 depicts an example of a transfer gate disposed at an inlet end of an inlet conveyor.

FIG. 5 depicts a flowchart of an example method for using the portable seed treater.

### DETAILED DESCRIPTION

A portable seed treatment system—hereinafter referred to as treatment system 100—can apply liquid treatment to a continuous stream of seed at a treatment flow rate that is based on a measured seed flow rate of the continuous stream. The continuous stream of seed may be received from a seed source at a seed flow rate that is consistent, with little to no variation. The measured seed flow rate may be pre-determined and assumed throughout operation of the treatment system 100 to treat the continuous stream at a consistent treatment flow rate.

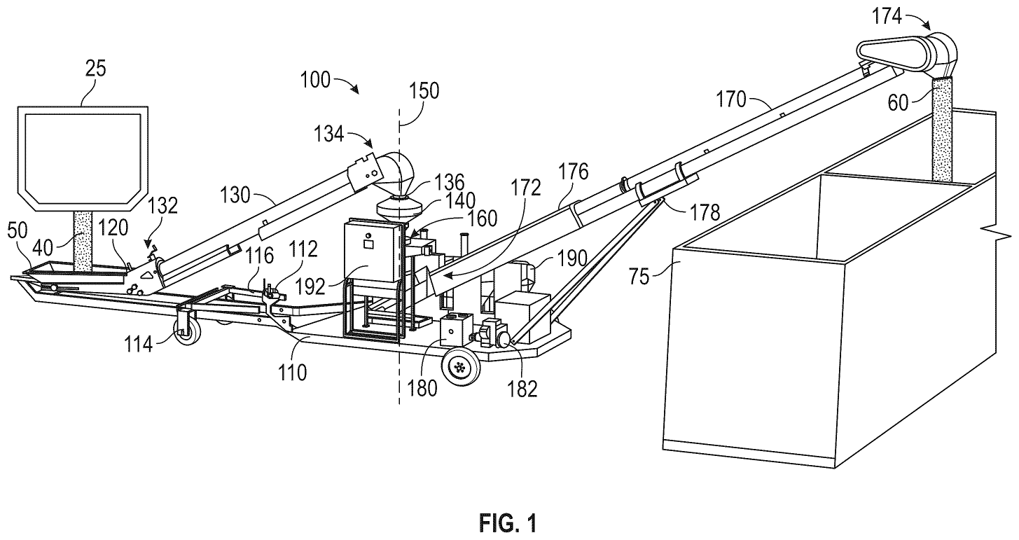

As shown in FIG. 1, treatment system 100 includes a trailer 110 which can support all of the treatment equipment on a self-contained portable unit. The trailer 110 may be hitched to and towed by a transport vehicle to and from a treatment site. The trailer 110 supports an inlet conveyor 130 of the treatment system 100. The inlet conveyor 130 is structured to receive an untreated stream 40 of seed dispensed from a seed source bin 25. The untreated stream 40 of seed is untreated in the sense that seed from the seed source bin 25 has not passed through the treatment system 100. The seed stored in the seed source bin 25 may be in a pre-treated or unadulterated state before treatment by the treatment system 100. The seed source bin 25 may be a bulk seed bin, such as a semi-trailer. At the treatment site, treatment system 100 that is unhitched may be positionally moved under seed source bin 25 by a steering drive mechanism 116. The steering drive mechanism 116 may be electrically, mechanically, hydraulically, or pneumatically powered by a generator 182 disposed on trailer 110. The steering drive mechanism 116 may raise or lower a first driven wheel 114. The steering drive mechanism 116 may have a control station 112 that is operably connected to the first driven wheel 114. Control station 112 may be stationed on trailer 110 for ease of access by an operator.

An intake hopper 50 at an inlet end 132 of inlet conveyor 130 may receive the seed dispensed from the seed source bin 25. The head height of the intake hopper 50 may be near the ground surface. A lower head height may be advantageous in treatment operations where the intake hopper 50 is maneuvered under a semi-trailer with a bottom outlet hopper. The head height of the intake hopper 50 may be between 10 inches to 60 inches, or further between 12 inches to 48 inches, between 10 inches to 24 inches, between 18 inches to 36 inches, between 24 inches to 48 inches, or between 36 inches to 60 inches from the ground surface.

The inlet conveyor 130 transports seed towards a calibration hopper 140 of the treatment system 100. The calibration hopper 140 may be vertically disposed between the inlet conveyor 130 and an outlet conveyor 170. Specifically, the calibration hopper 140 may be vertically disposed below a discharge end 134 of the inlet conveyor 130. The discharge end 134 of inlet conveyor 130 may be connected to the calibration hopper 140 by way of a transition element 136.

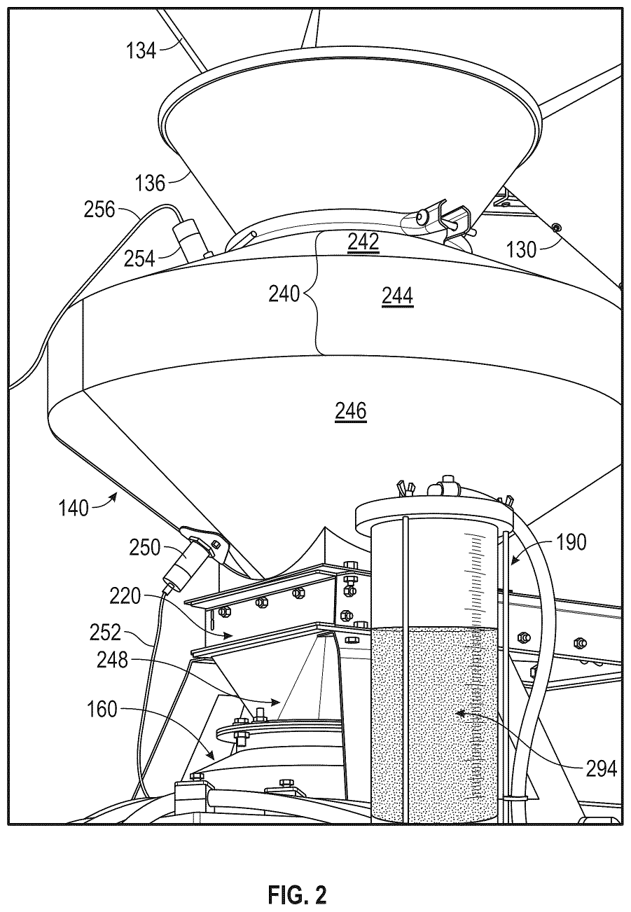

Calibration hopper 140 may be structured to receive agricultural seed discharged through transition element 136 under the force of gravity. As shown in FIG. 2, the transition element 136 is mounted above an upper section 240 of calibration hopper 140. The transition element 136 may be shaped like a funnel with a conical shape to assist in the discharge of agricultural seed from the inlet conveyor 130.

An upper rim seal disposed on an inlet side of transition element 136 may be mounted below the discharge end 134 of inlet conveyor 130. The upper rim seal may be a flanged gasket made of rubber or similar flexible material. The upper rim seal may enclose discharge end 134 of inlet conveyor 130 to prevent agricultural seed from ejecting or spilling over transition element 136.

A lower rim seal on an outlet side of transition element 136 may be mounted to the calibration hopper 140. The lower rim seal may be a circular clamp made of metal or similar rigid material. The lower rim seal may maintain mounting of the transition element 136 onto the upper section 240 of calibration hopper 140. The lower rim seal may circumferentially surround an upper aperture in calibration hopper 140 to form a circumferential seal with the upper section 240.

The upper section 240 may have an upper conical portion 242 and a middle cylindrical portion 244. The upper conical portion 242 may be mounted directly to the transition element 136 by the lower rim seal. The wall of the upper conical portion 242 may be angled to closely match an angle of repose of the agricultural seed that fills the calibration hopper 140. The angle of repose may be between 15° and 45°, or further between 15° and 35°, between 20° and 40°, between 25° and 35°, between 26° and 32°, between 28° and 32°, or between 26° and 30°. Agricultural seed discharged from the discharge end 134 of inlet conveyor 130 passes through the transition element 136 under the force of gravity into the upper conical portion 242.

Seed discharged from the inlet conveyor 130 may flow through the upper aperture to fill the calibration hopper 140 from a low-level to a high-level during a calibration phase. The capacity between the low-level and the high-level within calibration hopper 140 may be correlated to a volumetric measurement. The seed volume capacity of the calibration hopper 140 may be between 2 cubic feet to 10 cubic feet. The seed volume capacity of the calibration hopper 140 may be further between 2 cubic feet to 8 cubic feet, between 4 cubic feet to 10 cubic feet, between 4 cubic feet to 8 cubic feet, or between 2 cubic feet to 6 cubic feet. The seed weight capacity of the calibration hopper 140 may be between 50 pounds to 1,000 pounds. The seed weight capacity of the calibration hopper 140 may be further between 100 pounds to 800 pounds, between 100 pounds to 500 pounds, between 100 pounds to 400 pounds, between 300 pounds to 500 pounds, or between 200 pounds to 400 pounds. A measured seed flow rate may be calculated from the volumetric measurement divided by the time that seed takes to fill the interior space between the low-level and the high-level. The measured seed flow rate may be determined during the calibration phase without the use of load cells or a scale.

A pair of proximity sensors may be disposed in the wall of calibration hopper 140. An upper proximity level sensor may be disposed in the upper section 240 at a high-level in the calibration hopper 140 to generate a high-level signal. A lower proximity level sensor may be disposed in the lower section 246 in the calibration hopper 140 to generate a low-level signal. Alternatively, other types of sensors or detectors may be used, such as touch, ultrasonic, optical, or pressure types.

As shown in FIG. 2, a low-level sensor 250 is disposed within the lower section 246 of calibration hopper 140. The low-level sensor 250 may be positioned at a low-level which may be a minimum percentage of the capacity of the calibration hopper 140. The low-level may correlate to the minimum percentage of the capacity of the calibration hopper 140 that is less than 20%. The low-level may correlate to the minimum percentage of the capacity of the calibration hopper 140 that is between 1% to 15%, or further between 1% to 10%, or between 1% to 5%. The low-level sensor 250 may send a low-level signal 252 upon seed being sensed at the low-level.

A high-level sensor 254 is disposed within the upper section 240 of calibration hopper 140. Specifically, the high-level sensor 254 may be disposed in the upper conical portion 242 of calibration hopper 140. The high-level sensor 254 may be positioned at a high-level which may be a maximum percentage of the capacity of the calibration hopper 140. The high-level may correlate to the maximum percentage of the capacity of the calibration hopper 140 that is more than 80%. The high-level may correlate to the maximum percentage of the capacity of the calibration hopper 140 that is between 85% to 100%, or further between 90% to 100%, or between 95% to 100%. The high-level sensor 254 may send a high-level signal 256 upon seed being sensed at the high-level. As discussed previously, the wall of the upper conical portion 242 may be angled to closely match the angle of repose of agricultural seed filling the calibration hopper 140 to ensure the agricultural seed is sensed by the high-level sensor 254. Alternatively, the high-level sensor 254 may be disposed within the middle cylindrical portion 244 of calibration hopper 140.

A controller 180 may be operably connected to the low-level sensor 250 and high-level sensor 254. The connection between the sensors and the controller 180 may be hardwired or wireless. Controller 180 may be configured to measure a fill-time during the calibration phase between reception of the low-level signal 252 and high-level signal 256. Controller 180 may be further configured to calculate a measured seed flow rate based on the fill-time and a volume of the hopper between the low-level and the high-level. The measured seed flow rate may be associated with different seed sizes and types based on densities calibrated. Seed lots that have already undergone calibrating may be recorded in a database for subsequent treatment processing. Treatment system 100 may be recalibrated when a new seed lot or treatment site is first encountered by collecting a new density calibration.

Controller 180 may be operably connected to a gate control mechanism 350. Controller 180 may be programmed to send command output signals to activate and operate gate control mechanism 350. Controller 180 is also responsive to position feedback input signals received from gate control mechanism 350. A transmitter may be operably connected to gate control mechanism 350 to transmit the position feedback input signals to the controller 180. The gate control mechanism 350 may be electrically, mechanically, hydraulically, or pneumatically powered by the generator 182. For example, gate control mechanism 350 may be an air-assisted cylinder powered by generator 182 to provide selective control of a hopper gate 220.

Gate control mechanism 350 may be operably connected to the hopper gate 220 at the lower section 246 of calibration hopper 140. The hopper gate 220 may be adjustable and slide within a frame in a moveable manner. Controller 180 may be configured to selectively close and open the hopper gate 220. Hopper gate 220 may be closed by controller 180 at the start of the calibration phase. Hopper gate 220 may be retained in a closed position during the calibration phase. After the calibration phase has ended, hopper gate 220 may then be opened to dispense a measured stream of seed for treatment. Hopper gate 220 may regulate seed flow through the lower aperture disposed in the lower section 246. The lower section 246 may be shaped like a funnel with a conical shape to assist discharge of seed under the force of gravity through the lower aperture into a treatment applicator 160. A second transition element 248 may be mounted between the calibration hopper 140 and the treatment applicator 160.

Table 1, which follows, sets forth testing results obtained during calibration runs and operation runs of the treatment system 100:

TABLE 1

| | | | | | Actual | Rate |
|---|---|---|---|---|---|---|
| | | Cup | Calculated | Calculated | Run | Cali- |
| Treatment | Run | Weight | Flow Rate | Run Total | Total | bration |
| Site A | No. | (oz) | (lb./min) | (lbs.) | (lbs.) | Factor |
| Calibration | 1 | 40.25 | 306 | 1287 | 1176 | 0.91 |
| Runs | 2 | 40.25 | 730 | 2329 | 2271 | 0.98 |
| | 3 | 40.25 | 996 | 2366 | 2809 | 1.19 |
| | 4 | 40.25 | 1202 | 2594 | 3465 | 1.34 |
| | | | Adjusted | | | |
| | | | Calculated | | | |
| | | | Flow Rate | | | |
| | | | (lb./min) | | | Accuracy |
| Operation | 1 | 35.5 | 394 | 1749 | 1753 | 100.23% |
| Runs | 2 | 35.5 | 847 | 2198 | 2225 | 101.23% |
| | 3 | 35.5 | 1194 | 2626 | 2644 | 100.68% |
| | 4 | 35.5 | 1484 | 2545 | 2428 | 95.40% |
| | 5 | 35.5 | 1437 | 3321 | 3338 | 100.50% |
| | | | | | Actual | Rate |
| | | Cup | Calculated | Calculated | Run | Cali- |
| Treatment | Run | Weight | Flow Rate | Run Total | Total | bration |
| Site B | No. | (oz) | (lb./min) | (lbs.) | (lbs.) | Factor |
| Calibration | 1 | 35.5 | 911 | 2982 | 2450 | 0.82 |
| Runs | 2 | 35.5 | 1455 | 2843 | 2450 | 0.86 |
| | 3 | 35.5 | 1873 | 2901 | 2454 | 0.85 |
| | 4 | 35.5 | 2140 | 2810 | 2450 | 0.87 |
| | | | Adjusted | | Liquid | Liquid |
| | | | Calculated | | 1 | 2 |
| | | | Flow Rate | | Total | Total |
| | | | (lb./min) | | (oz) | (oz) |
| Operation | 1 | 35.5 | 1956 | 2861 | 260 | — |
| Runs | 2 | 35.5 | 2058 | 2816 | 251.71 | — |
| | 3 | 35.5 | 2495 | 3141 | 306.37 | — |
| | 4 | 35.5 | 2032 | 2880 | 214.23 | 139.5 |
| | 5 | 35.5 | 1976 | 2904 | 210.23 | 139.65 |
| | 6 | 35.5 | 2290 | 2770 | 201.14 | 132.78 |

In accordance with Table 1 above, testing results are shown for a treatment system 100 that was calibrated and operated at two treatment sites. At the start of the calibration phase, an operator of the treatment system 100 obtains a known volume of seed. The known volume of seed is weighed to obtain a cup weight. The cup weight may be recorded in a database for access by the controller 180. Multiplying the cup weight with a known volume of the calibration hopper 140, between the low-level and the high-level, gives a known weight of seed. Dividing the known weight of seed by the fill-time of the calibration hopper 140, between the low-level and the high-level, gives a calculated flow rate. The operator may measure the weight of the actual run total of seed processed by the treatment system 100 over a calibration run. Dividing the actual run total by the calculated run total gives a rate calibration factor.

The rate calibration factor may adjust the calculated flow rate to obtain an adjusted calculated flow rate. A plurality of rate calibration factors may be determined during a series of calibration runs. Up to ten, or more, rate calibration factors may be recorded in a database for access by the controller 180. Table 1 shows a plurality of adjusted calculated flow rates obtained from applying the rate calibration factors, by non-linear scaling, across a plurality of operation runs. Utilizing the rate calibration factor has been shown to increase the accuracy, which is the actual run total divided by the calculated run total. Once calibrated, treatment system 100 may be operated to treat seed with an accurate amount of liquid treatment based on the adjusted calculated flow rate.

As shown in FIG. 1, pumps and valves of an automated mixing system may be stationed on a pump stand 192 that is mounted to the trailer 110. The automated mixing system may be used to mix multiple ingredients to form a liquid treatment 294 before application. The automated system may improve the accuracy and consistency of the mixing process of the liquid treatment 294. The automated mixing system may involve the use of pumps and valves to control the treatment flow rate of the liquid treatment 294 during application.

A plurality of liquid treatments may be selected from the treatment source 190. The treatment source 190 may include the tanks and pumps that contain and transport the liquid treatments. The treatment source 190 may be mounted on trailer 110 and fluidly connected to the treatment applicator 160. Controller 180 may be configured to select a first liquid treatment from the treatment source 190 according to a recipe based on the measured seed flow rate. The first liquid treatment supplied by the treatment source 190 may be applied at a treatment flow rate that correlates with the measured seed flow rate.

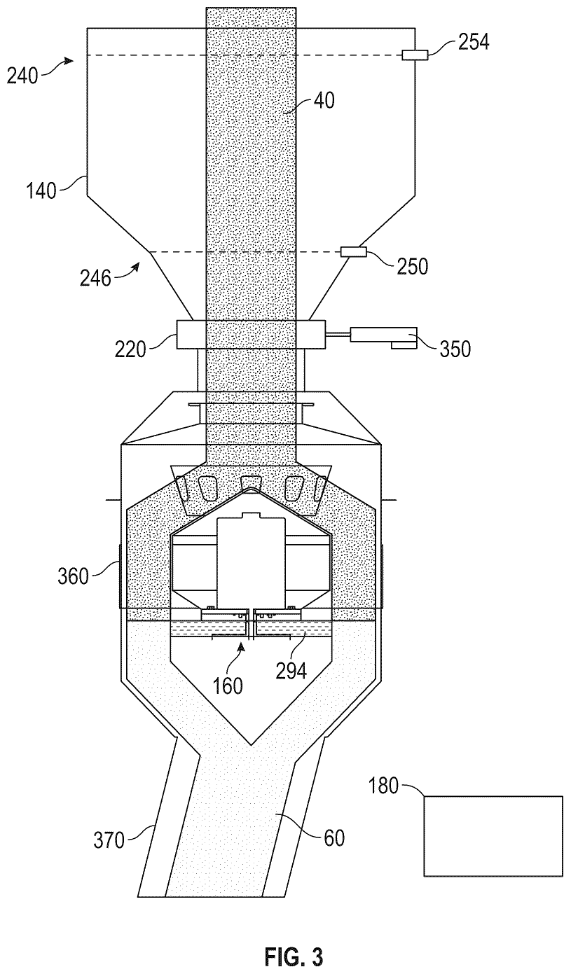

As shown in FIG. 3, treatment chamber 360 encloses the treatment applicator 160, both being disposed downstream of inlet conveyor 130. Treatment applicator 160 may be disposed vertically below the lower section 246 of calibration hopper 140. Treatment chamber 360 may be structured to receive seed discharged under the force of gravity from calibration hopper 140. A liquid treatment 294 from the treatment source 190 is applied to the untreated stream 40 within the treatment chamber 360 by the treatment applicator 160. Liquid treatment 294 may be applied to the untreated stream 40 of seed according to a recipe based on the measured seed flow rate. The treatment flow rate is established based on the measured seed flow rate determined during the calibration phase. A treated stream 60 of seed may be dispensed from treatment chamber 360 through a discharge chute 370.

Treated stream 60 of seed may be dispensed under force of gravity directly into an inlet end 172 of outlet conveyor 170. Treated stream 60 of seed may enter inlet end 172 of outlet conveyor 170 from the discharge chute 370. Treated stream 60 of seed may be transported through outlet conveyor 170 for discharge at a discharge end 174 of outlet conveyor 170.

Outlet conveyor 170 may have a conditioning portion 176. Conditioning portion 176 may include a plurality of mixing baffles that spread the liquid treatment 294 about the treated seed. Conditioning portion 176 mixes treated seed directly after application of liquid treatment 294 without a mixing drum disposed between conveyors. Conditioning portion 176 may include a first gas manifold with a plurality of inlet ports that cool and dry the treated seed. Conditioning portion 176 may include a second gas manifold with a plurality of outlet ports that exhaust air and particulates from inside the outlet conveyor 170. Conditioning portion 176 may condition the seed through a combination of mixing and drying until discharged as a treated stream 60 of seed. Treated seed is transported through outlet conveyor 170 towards a treated seed bin 75. The treated seed bin 75 may collect treated seed for field planting and other agricultural purposes.

The inlet conveyor 130 may be mounted inline with the outlet conveyor 170 on trailer 110 as shown in FIG. 1. Inline arrangement of inlet end 132 and discharge end 134 of inlet conveyor 130 relative with inlet end 172 and discharge end 174 of outlet conveyor 170 may decrease a width of trailer 110. A rearward portion of trailer 110 may have increased storage space by mounting inlet conveyor 130 forwardly inline of outlet conveyor 170. Inline arrangement may contribute to the portability of treatment system 100 when transported.

The trailer 110 is structured to support and transport the inlet conveyor 130 and the outlet conveyor 170 between multiple treatment sites. The inlet conveyor 130 may be structured to swing about and pivot upon a vertical axis 150 disposed through discharge end 134 as seen in FIG. 1. This pivoting action may allow the inlet end 132, which is distal to the discharge end 134, to be moved so that an intake hopper 50 of inlet conveyor 130 can be positioned under a seed source bin 25 for reception of seed. Intake hopper 50 may receive seed directly from the seed source bin 25 without the use of a separate conveyor to transport seed from the seed source bin 25 into intake hopper 50.

The outlet conveyor 170 may be structured to pivot upon the inlet end 172 of the outlet conveyor. This pivoting action may allow the discharge end 174 of the outlet conveyor 170 to raise and lower based on a head height of the treated seed bin 75. An elevator mechanism 178 may be structured with a pin-in-slot joint to raise and lower the outlet conveyor 170 between 15° and 45°, or further between 15° and 35°, between 20° and 40°, between 25° and 35°, or between 20° and 30°. The elevator mechanism 178 may be electrically, mechanically, hydraulically, or pneumatically powered by generator 182.

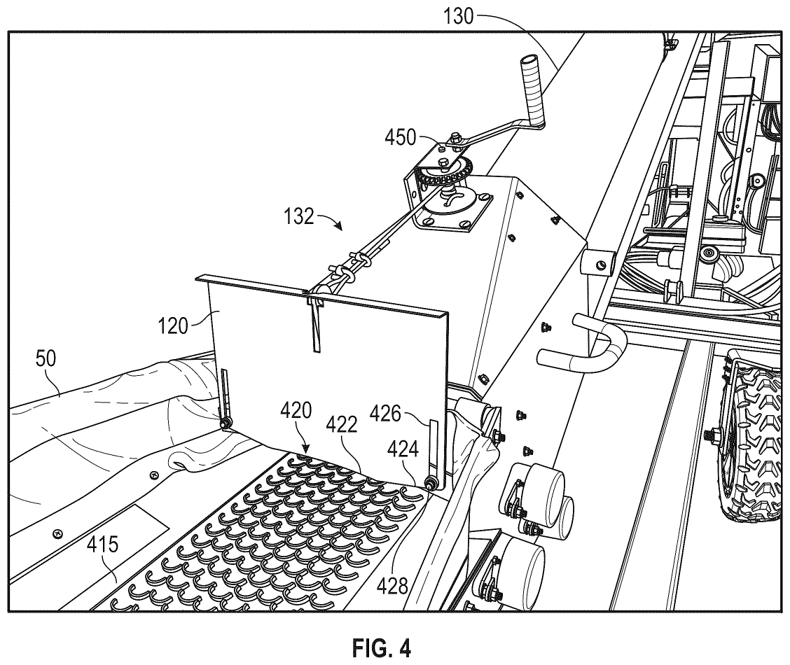

As shown in FIG. 1, a transfer gate 120 may be disposed upstream of the inlet conveyor 130. The transfer gate 120 may control the inflow rate of the untreated stream 40 of seed into the inlet conveyor 130. Now referring to FIG. 4, the transfer gate 120 is shown disposed above a floor 415 of the intake hopper 50 of inlet conveyor. A first gap edge 422 and a second gap edge 424 of the transfer gate 120 may correspond to a surface profile of an underlying belt residing upon floor 415.

The transfer gate 120 may be selectively raised or lowered, by gate adjustment mechanism 450, to increase or decrease a gap opening 420 between the transfer gate 120 and the floor 415, respectively. Gate adjustment mechanism 450 may be manually operated or controlled automatically by a controller to move the transfer gate 120 upon an adjustment slot 426 with a fastener pin 428. The transfer gate 120 may be raised to a first adjustment position to increase the gap opening 420. The transfer gate 120 at the first adjustment position may allow for greater bypass of the untreated stream 40 of seed into the inlet conveyor 130. The transfer gate 120 may be lowered to a second adjustment position to decrease the gap opening 420. Transfer gate 120 at the second adjustment position may allow for reduced bypass of the untreated stream 40 of seed into the inlet conveyor 130. Choke feeding the untreated stream 40 of seed into the inlet conveyor 130 may regulate situations where the inlet conveyor 130 has a greater seed flow transfer rate than the outlet conveyor 170. Transfer gate 120 may also regulate backflow of seed that falls backwards towards inlet end 132 of inlet conveyor 130.

Gap opening 420 may be increased or decreased based on the inflow rate of the untreated stream 40 of seed. The gap opening 420 may be adjusted based on a transfer capacity of the inlet conveyor. The seed flow rate through the inlet conveyor may be increased or decreased based on the adjusted position of transfer gate 120. The seed flow rate may be between 1,000 pounds per minute (lbs./min.) to 3,000 lbs./min., or may be further between 1,500 lbs./min. to 2,500 lbs./min., between 1,750 lbs./min. to 2,750 lbs./min., between 1,250 lbs./min. to 2,750 lbs./min., between 1,250 lbs./min. to 2,250 lbs./min., between 1,000 lbs./min. to 2,000 lbs./min., or between 2,000 lbs./min. to 3,000 lbs./min.

Controller 180 may be an automated controller such as a computer serving as a programmable logic controller (PLC) that automatically controls operations of treatment system 100. The controller may be an automated controller such as a proportional integral derivative (PID) loop controller that automatically controls operations of treatment system 100. Controller 180 may include programming for interfacing with sensors and gate control mechanisms. Controller 180 may have mastery of treatment system 100 by being hardwired (i.e., ethernet, data protocol, serial link) or wireless (i.e. Wi-Fi, Bluetooth, mobile, etc.).

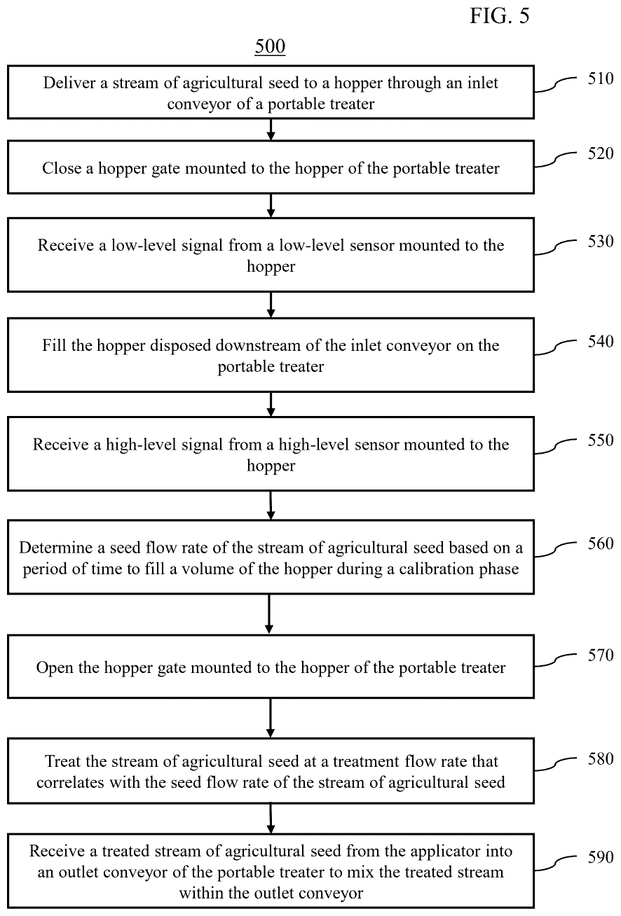

FIG. 5 is a flowchart of an example method 500 for using the portable seed treater. A stream of agricultural seed is delivered into a hopper by an inlet conveyor which is mounted to the portable seed treater upstream of the hopper at step 510. The seed flow rate of the stream of agricultural seed may be adjusted by a gate mounted upstream of the inlet conveyor. A gate mounted to the hopper is closed at step 520. A low-level signal is received by a controller from a low-level sensor mounted to the hopper as the stream of agricultural seed begins to fill the hopper at step 530. During a calibration phase, the hopper is filled from the low-level to a high-level to measure the seed flow rate of the stream of agricultural seed at step 540. A high-level signal is received by the controller from a high-level sensor mounted to the hopper when the agricultural seed fills the hopper to a high-level at step 550. A measured seed flow rate is determined by the controller based on a period to fill the hopper between reception of the low-level signal and the high-level signal during the calibration phase at step 560. Alternatively, the measured seed flow rate may be determined by the controller based on a period to fill the hopper between reception of a low-weight signal and a high-weight signal during the calibration phase. The controller may calculate a volumetric measurement against the fill-time to determine the measured seed flow rate. The gate mounted to the hopper is opened at step 570. The stream of agricultural seed is treated by an applicator at a treatment flow rate that correlates with the measured seed flow rate at step 580. A treated stream of agricultural seed is received into an outlet conveyor from the applicator at step 590. The treated stream of agricultural seed may be mixed within the outlet conveyor before being collected into a treated seed bin.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

We claim:

1. An agricultural seed treatment system comprising:
a. a trailer;
b. an inlet conveyor mounted to the trailer, the inlet conveyor comprising:
i. a discharge end;
c. an outlet conveyor mounted to the trailer inline with the inlet conveyor;
d. a hopper configured to receive agricultural seed from the inlet conveyor, the hopper comprising:
i. a lower conical section;
ii. an upper section;
iii. a hopper gate configured to selectively open and close an aperture in the lower conical section;
e. a low-level sensor disposed within the lower conical section of the hopper;
f. a high-level sensor disposed within the upper section of the hopper; and
g. an applicator configured to receive agricultural seed under the force of gravity from the hopper.

2. The agricultural seed treatment system of claim 1, further comprising:
a. a controller operably connected to the hopper gate, the low-level sensor, and the high-level sensor; and
b. wherein, during a calibration phase, the controller is configured to close the hopper gate and measure a fill time between reception of a low-level signal from the low-level sensor and a high-level signal from the high-level sensor.

3. The agricultural seed treatment system of claim 2, wherein the controller is further configured to calculate a seed flow rate based on the fill time and a volume of the hopper.

4. The agricultural seed treatment system of claim 3, further comprising:
a. a first liquid treatment source disposed on the trailer and operably connected to the applicator; and
b. wherein the controller is configured to treat the agricultural seed with a first liquid treatment from the first liquid treatment source according to a recipe based on the seed flow rate.

5. The agricultural seed treatment system of claim 3, further comprising:
a. a transfer gate disposed upstream of the inlet conveyor to control the seed flow rate of agricultural seed.

6. The agricultural seed treatment system of claim 1, wherein the capacity of the hopper is between 2 cubic feet to 10 cubic feet.

7. The agricultural seed treatment system of claim 1, wherein the hopper is vertically disposed between the inlet conveyor and the outlet conveyor.

8. The agricultural seed treatment system of claim 1, wherein the hopper is vertically disposed below the discharge end of the inlet conveyor.

9. The agricultural seed treatment system of claim 1, wherein the applicator is vertically disposed below the lower conical section of the hopper.

10. A method of using the agricultural seed treatment system of claim 3, comprising the steps of:
a. delivering a stream of agricultural seed from the inlet conveyor into the hopper;
b. filling the hopper disposed downstream of the inlet conveyor;
c. determining the seed flow rate based on a period to fill the hopper between the low-level sensor and the high-level sensor of the hopper during a calibration phase; and
d. adjusting a treatment flow rate of the applicator to continuously treat the stream of agricultural seed at the seed flow rate.

11. The method of claim 10, further comprising the step of:
a. closing a gate of the hopper;
b. receiving, by a controller, a low-level signal from the low-level sensor;
c. receiving, by the controller, a high-level signal from the high-level sensor; and
d. calculating, by the controller, the seed flow rate of the stream of agricultural seed delivered from the inlet conveyor into the hopper.

12. The method of claim 11, further comprising the step of:
a. treating, by the applicator, the stream of agricultural seed at the treatment flow rate that correlates with the seed flow rate determined during the calibration phase.

13. The method of claim 12, further comprising the step of:
a. receiving the stream of agricultural seed from the applicator into the outlet conveyor; and
b. mixing the stream of agricultural seed within the outlet conveyor.

14. The method of claim 13, wherein the hopper is disposed between the inlet conveyor and the outlet conveyor.

15. The method of claim 11, further comprising the step of:
a. adjusting, by the controller, the seed flow rate of the stream of agricultural seed with a transfer gate disposed upstream of the inlet conveyor.

16. The method of claim 15, further comprising the step of:
a. increasing, by the controller, a gap opening of the transfer gate based on an increase in an inflow rate of the stream of agricultural seed into the inlet conveyor; and
b. decreasing, by the controller, the gap opening of the transfer gate based on a decrease in the inflow rate of the stream of agricultural seed into the inlet conveyor.

17. The method of claim 15, further comprising the step of:
a. increasing the seed flow rate of the stream of agricultural seed through the inlet conveyor based on an increase in a gap opening of the transfer gate; and
b. decreasing the seed flow rate of the stream of agricultural seed through the inlet conveyor based on a decrease in the gap opening of the transfer gate.

18. The method of claim 11, wherein the seed flow rate is between 1,000 pounds per minute to 3,000 pounds per minute.

19. An agricultural seed treatment system comprising:
a. a trailer;
b. an inlet conveyor mounted to the trailer, the inlet conveyor comprising:
c. a transfer gate disposed upstream of the inlet conveyor to control a seed flow rate of agricultural seed;
d. an outlet conveyor mounted to the trailer inline with the inlet conveyor, the outlet conveyor comprising:
i. an inlet end;
ii. a discharge end; and
e. an applicator disposed downstream of the inlet conveyor and configured to dispense agricultural seed under the force of gravity into the inlet end of the outlet conveyor.

20. The agricultural seed treatment system of claim 19, further comprising:
a. a hopper configured to receive agricultural seed from the inlet conveyor, the hopper comprising:
i. a lower conical section;
ii. an upper section;
iii. a hopper gate configured to selectively open and close an aperture in the lower conical section;
b. a low-level sensor disposed within the lower conical section of the hopper,
c. a high-level sensor disposed within the upper section of the hopper, and
d. wherein the applicator is configured to receive agricultural seed under the force of gravity from the hopper.
